(19) United States
(12) Patent Application Publication
(10) Pub. No.: US 2026/0319152 A1
(43) Pub. Date: Oct. 15, 2026

(54) POLARIZATION ABERRATION COMPENSATOR

(71) Applicant: Arizona Board of Regents on Behalf of the University of Arizona, Tucson, AZ (US)

(72) Inventor: Stanley PAU, Tucson, AZ (US)

(21) Appl. No.: 19/101,168

(22) PCT Filed: Aug. 4, 2023
(86) PCT No.: PCT/US2023/071665

§ 371 Date: Feb. 4, 2025

Related U.S. Application Data
(60) Provisional application No. 63/370,440, filed on Aug. 4, 2022.

(51) Int. Cl. G02B 5/30; G02B 27/00

(52) U.S. Cl. CPC G02B 5/3016; G02B 27/0012

(57) ABSTRACT

Polarization aberration compensator devices, systems and methods for their design and fabrication are described. An example polarization aberration compensator includes a substrate, and one or more sets of layers positioned on the substrate. Each of the one or more sets of layers is spatially divided into multiple sections, and each of the sections is configured to impart a different amount diattenuation or retardance compared to another one of the sections to form a spatially varying polarization correction configuration across the polarization aberration compensator. Additionally, the amount diattenuation or retardance imparted by each of the sections is customized based on polarization characteristics of a corresponding optical system to eliminate or reduce polarization aberrations over, for example, the exit pupil of the optical system.

### CROSS-REFERENCE TO RELATED APPLICATION(S)

This application claims priority to the provisional application with Ser. No. 63/370,440 titled “POLARIZATION ABERRATION COMPENSATOR,” filed Aug. 4, 2022. The entire contents of the above noted provisional application are incorporated by reference as part of the disclosure of this document.

### TECHNICAL FIELD

This description in this patent document relates to methods and devices for controlling polarization aberrations.

### BACKGROUND

Controlling polarization aberration is an important problem in high performance optical systems, such as microscopy, metrology, lithography, high resolution imaging, display, augmented reality, virtual reality systems and others. This is especially relevant for optical systems with birefringent and polarizing optical components, such as metamaterial lenses and liquid crystal lenses. Therefore, there is a need for optical devices that can reduce or eliminate polarization aberrations in optical systems with low cost and complexity.

### SUMMARY

The disclosed embodiments, among other features and benefits, relate to polarization aberration compensator devices and systems and methods for design and fabrication of the same. The disclosed methods, devices and systems can be used to reduce the overall polarization aberration of optical systems by designing and incorporating the polarization aberration compensators described herein. The ideal polarization aberration compensator should have low optical loss and depolarization, be easy to manufacture, and not introduce any new polarization aberration.

An example polarization aberration compensator includes a substrate, and one or more sets of layers positioned on the substrate. Each of the one or more sets of layers is spatially divided into a plurality of sections, and each of the plurality of sections is configured to impart a different amount diattenuation or retardance compared to another one of the plurality of sections to form a spatially varying polarization correction configuration across the polarization aberration compensator. Additionally, the amount diattenuation or retardance imparted by each of the plurality of sections is customized based on polarization characteristics of a corresponding optical system to eliminate or reduce polarization aberrations over an exit pupil of the optical system.

### BRIEF DESCRIPTION OF THE DRAWINGS

FIG. 1 illustrates object and image planes, and entrance and exit pupils of an optics system.

FIG. 2 illustrates a diagram for determining the Jones pupil based on rays that are normal to a polarization aberration compensator in accordance with one or more example embodiments.

FIG. 3 illustrates a polarization aberration compensator in accordance with an example embodiment.

FIG. 4 illustrates a polarization aberration compensator that includes a substrate and multiple groups of coatings in accordance with an example embodiment.

FIG. 5 is an example Hurter-Driffield (H-D) curve, illustrating the relationship between irradiation dosage (D) and crosslinked photoresist film thickness (H) for a negative photoresist.

FIG. 6 illustrates a fabrication process for a spatially varying coating in accordance with an example embodiment.

FIG. 7 illustrates a set of operations that can be carried out to design a polarization aberration compensator for an optical system in accordance with an example embodiment.

### DETAILED DESCRIPTION

The polarization aberration of an optical system describes the deviation of the output wavefront from an ideal wavefront such as a wavefront with uniform polarization state. An ideal optical system without polarization aberration does not change the polarization state of the input light. A nonideal optical system includes polarization aberration which changes the polarization state of the input light. Sources of polarization change include different transmission and reflection coefficients between orthogonal polarization states of light and geometric transformation of propagating light rays. The latter source is often called skew aberration. Polarization aberration can be characterized by the polarization aberration function or the Jones pupil, J_{sys}(h, ρ, λ), which is a spatially varying Jones matrix that describes all the polarization changes of the optical system:

$${J}_{sys} ( h , ρ , λ ) = [ \begin{matrix}{j}_{sys , 11} ( h , ρ , λ ) & {j}_{sys , 12} ( h , ρ , λ ) \\ {j}_{sys , 21} ( h , ρ , λ ) & {j}_{sys , 22} ( h , ρ , λ )\end{matrix} ] . \qquad ( 1 )$$

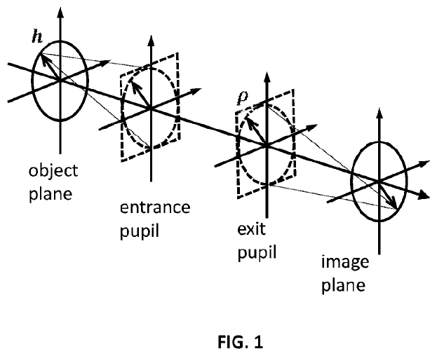

The Jones pupil is a function of object coordinate, h, exit pupil coordinate, ρ, and wavelength, λ. FIG. 1 illustrates a configuration of an optics system, showing the object plane, the entrance pupil, the exit pupil and the image plane. Polarization aberration generally can be divided into two contributions: diattenuation and retardance. Diattenuation converts unpolarized light into polarized light, and retardance converts one type of polarized light into another type of polarized light. For most optical systems, the dominant contributions are linear diattenuation and linear retardance, which describe the effects on linear s- and p-polarization states. In some optical systems, there can be circular diattenuation and circular retardance, which describe the effects on right-handed and left-handed circular polarization states. In yet other optical systems, there can be elliptical diattenuation and elliptical retardance, which describe the effects on right-handed and left-handed elliptical polarization states.

The disclosed polarization aberration compensators act to remove or reduce unwanted components of polarization aberration from an optical system. In the ideal case, the polarization aberration compensator has a Jones matrix, J_{pac}, that is equal to the inverse of the Jones pupil,

$${J}_{pac} = {J}_{sys}^{- 1} ,$$

such that the product J_{pac}J_{sys} is equal to unity (the identity matrix).

$${J}_{pac} {J}_{sys} = 1. \qquad ( 2 )$$

In some applications, achieving this result may not be feasible, so the product may be a predetermined value or matrix that produces an acceptable level of polarization aberration. J_{pac} is spatially varying, i.e., is a function of ρ. To facilitate the description, J_{pac} is determined for the polarization aberration compensator that is positioned at the exit pupil of the optical system. Such a position may be convenient for many optical systems, where the exit pupil is accessible and can accommodate additional components, such as the polarization aberration compensator. However, the disclosed polarization aberration compensators can be placed at other locations within the optical system, which with reference to FIG. 1, can include any location(s) between the object plane and the image plane. In those scenarios, J′_{pac} is computed for the compensator that is located at the particular location of interest. J′_{pac} is determined such that the polarization aberration at the exit pupil is equal to or close to zero. If J_{sys,before} and J_{sys,after} are the Jones matrices of the system before and after the polarization aberration compensator, respectively, then the following condition should be satisfied:

$${J}_{sys , after} {J}_{pac}^{′} {J}_{sys , before} = 1. \qquad ( 3 )$$

The value of J′_{pac} depends on the position of the polarization aberration compensator, and this position can be chosen to have a simplified J′_{pac}, for example in location where there is symmetry in the optical system. A simplified J′_{pac} can lead to a polarization compensator that is easier to fabricate and manufacture.

One method for determining the value of J_{sys} is to use polarization raytracing programs, such as Polaris-M Software from Airy Optics, Tucson, Arizona. Alternatively, a Mueller matrix polarimeter can be used to measure the system Mueller matrix M_{sys}(h, ρ, λ) which is related to the Jones matrix. In this case, the polarization aberration compensator has a Mueller matrix M_{pac} that is equal to the inverse of M_{sys}, such that the product M_{sys}M_{pac} is equal to or close to the identity matrix, similar to the above description for the Jones pupil. If M_{sys,before} and M_{sys,after} are the Mueller matrices of the system before and after the polarization aberration compensator, respectively, then the following condition should be satisfied:

$${M}_{sys , after} {M}_{p a c} {M}_{sys , before} = 1. \qquad ( 4 )$$

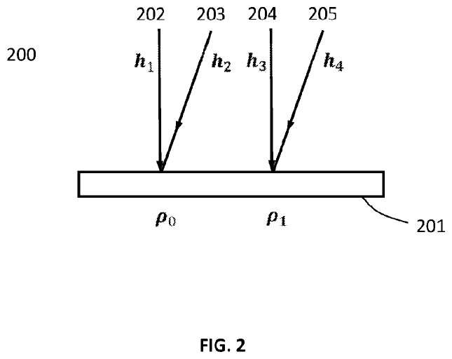

The Jones pupil, J_{sys}, also depends on the object coordinates h. There are several approaches to determine which J_{pac} to use for the polarization aberration compensator. In some embodiments, the Jones pupil at the center of the object, i.e., J_{sys}|_{h=(0,0)} is used. In alternate embodiments, one can use the spatial average Jones pupil, J̅_̅{̅s̅y̅s̅}̅, over the object area in the object plane. In still other embodiments, a Jones pupil where the ray incident on the aberration compensator is at direct normal to the plane of the compensator is used. This configuration 200 is illustrated in FIG. 2, where a thin planar polarization aberration compensator 201 is placed at the plane of the exit pupil. An incoming ray 202 from the object plane location h₁ is incident at direct normal to the compensator at the location ρ₀. Another incoming ray 203 from the object plane location h₂ is incident at a finite (i.e., non-normal) angle to the compensator at the same location ρ₀. In this case, the value of J_{sys}|ₕ₌ₕ_{₁}, which can be calculated using polarization raytracing of the optical system, can be used to determine J_{pac} at location ρ₀. Similarly, the value of I_{sys}|ₕ₌ₕ_{₃} can be used to determine J_{pac} at location ρ₁. If there is more than one ray that is normally incident at the same location, the average Jones matrix of the different rays can be used. If there is no ray that is normally incident, then Jones matrix of the ray that is closest to normal incidence can be used. In some embodiments, additional polarization compensation layers can be used to compensate for both the rays with normal and non-normal angles of incidence. The polarization compensation layers are described below.

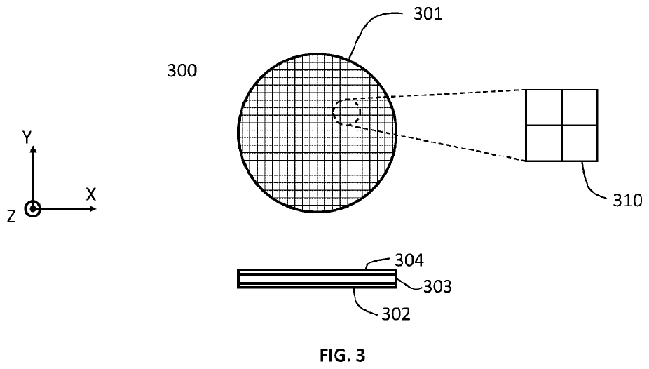

FIG. 3 illustrates a polarization aberration compensator 300 that includes a transparent substrate 303 with a polarization compensation coating 304 and an antireflective coating 302. In some configurations, an additional antireflective coating (not shown) can be placed on top of polarization compensation coating 304. The area of the compensator 301 is divided into different sections, wherein four such sections 310 are illustrated in the zoomed-in panel of FIG. 3. Each section 310 has a uniform diattenuation and retardance, which can be different from one section to another. The dimensions of each section 310 can range from 100 nm to 100 mm, limited by the fabrication process, and by the properties of the material. With the current manufacturing and processing capabilities, a typical section may have a dimension as small as 5 to 200 microns, depending on the material. The shape of the section can be square, round, triangular, or other shapes. Depending on the process (e.g., lithography) that is used to fabricate the filter, it is possible to vary the diattenuation and retardance continuously across the compensator by discretizing the area 301 into small uniform sections 310. There can be many thousands of sections in some implementations. The division of the area 301 to multiple uniform sections 310 simplifies the design and the fabrication processes.

In some embodiments, the coating 304 includes multiple layers of isotropic and birefringent coatings, which can be made of, for example, polymer, oxide, sol-gel, liquid crystal polymer, liquid crystal polymer doped with dyes, metamaterials, birefringent crystal, form birefringent material and a combination thereof. The liquid crystal material can be uniaxial or biaxial and can be nematic, smectic or cholesteric phase.

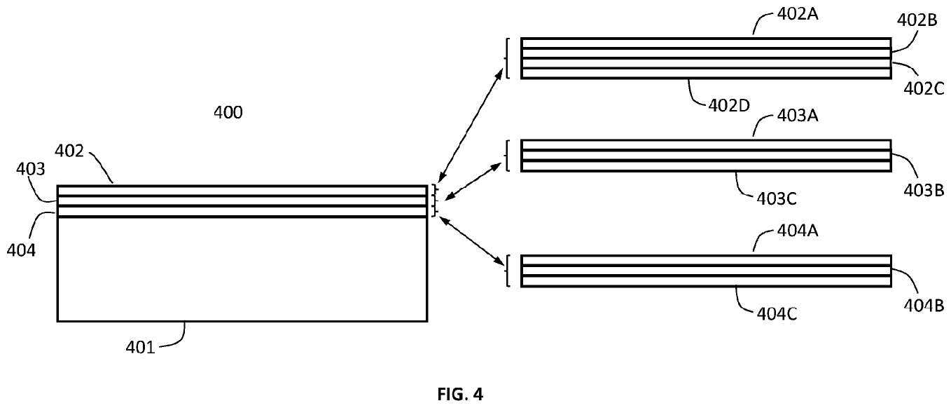

FIG. 4 illustrates an example embodiment of the polarization aberration compensator 400, which includes a transparent substrate 401 and three groups of coatings, 402, 403, and 404. The coating group 404 acts as a polarizer with spatially varying diattenuation. The coating group 403 acts as a transparent retarder with spatially varying retardance. The coating group 402 improves the transmission and angular response of the polarization aberration compensator 400. In general, each group of coatings includes multiple layers of isotropic and birefringent materials. In one embodiment, the coating group 402 includes an antireflection coating 402A, a transparent barrier and planarization layer 402B, a C-plate liquid crystal polymer layer 402C, and a photoalignment layer 402D. The coating group 403 includes a barrier and planarization layer 403A, an A-plate liquid crystal polymer layer 403B and a photoalignment layer 403C. The coating group 404 is made of a barrier and planarization layer 404A, an A-plate liquid crystal polymer layer 404B doped with dichroic dye and a photoalignment layer 404C.

For some applications, only coating group 403 is used. In other applications only coating group 404 is used. In some other applications, both coating groups 403 and 404 are used. In yet another application, the coating group 403 includes a barrier and planarization layer 403A, a cholesteric liquid crystal polymer layer 403B and a photoalignment layer 403C. The final implementation depends on the transmission and angular requirements of the compensator and the amount of diattenuation and retardance that are needed for the compensation. Additional coating groups can be added to improve the performance of the polarization aberration compensator. For each group of coatings or layers, an additional liquid crystal polymer layer can be added to improve the spectral and angular bandwidth of the compensator. As an example, the design of an elliptical polarizer includes linear and circular polarizers as special cases, with arbitrary eigen-polarization states. The diattenuation of the elliptical polarizer can be tuned by changing the diattenuation of the linear polarizer in the elliptical polarizer. If the linear polarizer is a dye-based polarizer, the diattenuation can be tuned by changing the concentration of the dye. If the linear polarizer is a wire grid polarizer, the diattenuation can be tuned by changing the dimensions of the wire grid. As another example, the design of an elliptical retarder can include linear and circular retarders as special cases, with arbitrary eigen-polarization states. The retardance of the elliptical retarder can be tuned by changing the thickness of the birefringent layer in the design.

For broadband operation of the polarization aberration compensator, the wavelength dispersion of the liquid crystal polymer must be considered in the design. In most cases, the birefringent dispersion Δn(λ) can be described accurately using a single band dispersion model:

$$Δ n ( λ ) = G \frac{{λ}^{2} {λ}_{0}^{2}}{{λ}^{2} - {λ}_{0}^{2}} . \qquad ( 5 )$$

Here, G and λ₀ are constants. In some instances, the liquid crystal polymer material is engineered to produce low dispersion across a wide range of wavelengths.

In other embodiments, a wire-grid polarizer, and a nonuniform retarder layer, such as liquid crystal polymer with varying angles and/or thicknesses, can be used to construct a spatially varying elliptical polarizer. Achromatic elliptical polarizers can thus be designed, fabricated and tested using multiple layers of liquid crystal polymer and polarizer.

In designing each layer, different approaches can be used for determining the thickness, dye concentration, and angle for each layer (and more specifically, for one or more sections in each layer). In one approach, the thickness and angle of each layer at each location (i.e., for one or more sections) can be calculated using a nonlinear optimization routine which minimizes the deviation of the Jones matrix of the compensator from

$${J}_{s y s}^{- 1} ,$$

with the goal of eliminating or reducing the polarization aberration of the optical system. In another approach, the value of

$${J}_{s y s}^{- 1}$$

is decomposed into different diattenuation and retardance components using the Pauli spin matrices. The angle and thickness of each layer can be chosen to cancel the existing diattenuation and retardance of the optical system. In yet another approach, the thickness and angle of each layer at each location can be calculated from a nonlinear optimization routine which minimizes the deviation of the Mueller matrix of the compensator from

$${M}_{s y s}^{- 1} ,$$

obtained from measurement of the optical system. The technique can be extended to multiple wavelengths to cover a range of the spectrum. The technique can also be extended to multiple angles of incidence to compensate light incident at a range of angles. For example, a C-plate liquid crystal polymer can be used to improve the angular performance of reflective components (e.g., a metallic mirror) by reducing polarization aberration. Addition of a C-plate liquid crystal polymer with optimized thickness can improve the angular performance of the polarization aberration compensator. This is possible, in view of the fact that the diattenuation and retardance of many optical systems vary quadratically with the angle of incidence. A properly chosen C-plate design with diattenuation and retardance in the opposite sign can reduce and potentially cancel this angular variation.

The fabrication process for the liquid crystal polymer is described in U.S. Pat. Nos. 8,866,997 and 10,254,453. Two important parameters for the group of coatings such as coating group 403 are the thickness and angle of the photoalignment layer. The angle of the photoalignment layer determines the angle of the fast axis of the nematic liquid crystal polymer and the geometric phase of the cholesteric liquid crystal polymer. Depending on the design of the polarization aberration compensator, the angle of the photoalignment layer and its thickness are functions of position along the x-axis and y-axis. In some embodiments, only the angle changes, and the thickness is fixed. In some embodiments, the thickness changes and the angle are fixed. In yet other embodiments, both the angle and the thickness change. The angle of the photoalignment layer can be controlled, in one example, by polarized ultraviolet photolithography. The thickness of the layer can be controlled, in one example, by grayscale photolithography and etching.

For each optical system with a given J_{sys}, the design for the polarization aberration compensator, such as number of layers, thickness of each layer or one or more sections of each layer, angles and materials, are not unique, and there are a large number of solutions. Some solutions use many layers, while others that use fewer number of layers are easier to manufacture but have a larger deviation from the optimal value. The final solution for each optical system depends on the cost, customer specifications and methods of implementation available to the designer. For some applications, the Jones matrix of the compensator is set to a design value J_{design}, instead of

$${J}_{s y s}^{- 1}$$

such that:

$${J}_{s y s} {J}_{d e s i g n} = 1 \qquad ( 6 )$$

The disclosed polarization aberration compensators exhibit low loss, with transmission or reflection efficiencies of more than 90%. The disclosed compensators are also lightweight, and can be made with small footprints, which makes them particularly suitable for virtual reality eyewear. The disclosed polarization aberration compensators can be placed on an existing substrate, such as the back of a lens or on an optical filter in the existing optical system. In some embodiments, the different layers (e.g., those shown in FIG. 4) can be placed on different substrates instead of a single substrate.

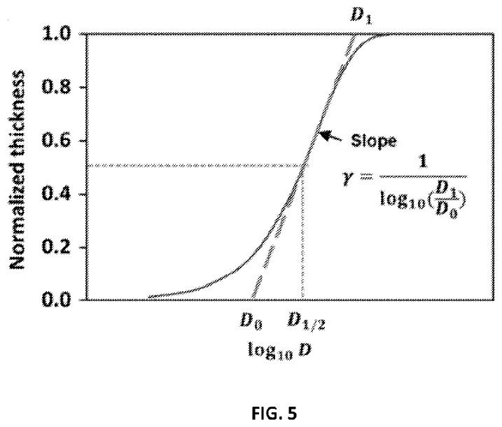

As noted earlier, the disclosed polarization aberration compensators have spatially varying characteristics. The description that follows provides example processes that can be utilized for making the polarization aberration compensators regarding. The photoresist contrast curve, or the Hurter-Driffield (H-D) curve, describes the relationship between the irradiation dosage (D) and the crosslinked photoresist film thickness (H) for a constant development rate throughout the photoresist film. The curve for a negative photoresist is shown in FIG. 5, and is governed by:

$$H ( D ) = 1 - a \cdot {10}^{- D / b} . \qquad ( 7 )$$

Here, a and b are fitting constants. D₀, D_{1/2}, and D₁ are the lowest dose to realize the thinnest possible photoresist, dose to obtain half the film thickness, and saturation dose respectively. The contrast y of the photoresist is given by:

$$γ = \frac{1}{{log}_{10} ( {D}_{1} / {D}_{0} )} . \qquad ( 8 )$$

A photoresist with a low contrast is ideally suitable for grayscale lithography. The thickness of the photoresist is varied as a function of position by spatially changing the ultraviolet radiation dosage during the writing process. The writing process can be performed by using a grayscale mask in a standard photolithography system or by a maskless lithographic system. As illustrated by the photoresist contrast curve, the different dosages lead to different thicknesses after the development of the photoresist.

In some embodiments, a polarizer (e.g., the polarizer in coating group 404) can be made by using a liquid crystal polymer doped with a dichroic material. A dichroic material such as a dichroic dye absorbs light of one polarization more than light of the orthogonal polarization. A mixture of different dichroic dyes can be used to cover a range of optical spectrum. A dichroic ratio (DR) for a dichroic material can be defined as:

$$D R = \frac{{α}_{⊥} ( c , λ )}{{α}_{‖} ( c , λ )} . \qquad ( 9 )$$

Here, α_{⊥}(c, λ) and α_{β}(c, λ) are the absorption coefficients of the parallel and perpendicular polarization states, respectively. λ is wavelength of light, and c is the concentration of dyes. For low concentrations, the absorption coefficient is linearly related to the concentration. The extinction ratio, ER, of the polarizer can be defined to be the ratio of the transmittance, T_{|} and T_{⊥}, of the parallel and perpendicular polarization states:

$$ER = \frac{{T}_{‖}}{{T}_{⊥}} = \frac{exp ( - {α}_{‖} ( c , λ ) H )}{exp ( - {α}_{⊥} ( c , λ ) H )} . \qquad ( 10 )$$

The extinction ratio, ER, is a function of the absorption coefficients and thickness of the material H. The extinction ratio, ER, is related to the dichroic ratio, DR, as follows:

$$D R = 1 - \frac{ln ( {T}_{‖} )}{ln ( ER )} . \qquad ( 11 )$$

The extinction ratio, ER, is also related to the diattenuation of the polarizer, D_{polarizer}, as follows:

$$E R = \frac{1 + {D}_{polarizer}}{1 - {D}_{polarizer}} . \qquad ( 12 )$$

The diattenuation of the polarizer can be controlled by changing the dye concentration, the thickness of the layer or both. A polarizer using liquid crystal polymer doped with dichroic dye has both diattenuation and retardance.

In some embodiments, a polarizer (e.g., the polarizer in coating group 404) can also be made by using a cholesteric liquid crystal polymer with or without doping with a dichroic material. A cholesteric liquid crystal polymer reflects light of one circular polarization state and transmits light of the orthogonal circular polarization state. The diattenuation of such a polarizer can be controlled by changing the thickness of the layer or by changing the dye concentration, if a dye is used.

In some embodiments, a retarder (such as the retarder in coating group 403) can be made by using a liquid crystal polymer. The retardance is described by a phase change between two eigenpolarizations. For a retarder with refractive indices n₁ and n₂, the retardance δ is related to the indices and the thickness.

$$δ = \frac{2 π ( {n}_{1} - {n}_{2} ) H}{λ} . \qquad ( 13 )$$

The retardance of the retarder can be controlled by changing the thickness of the layer.

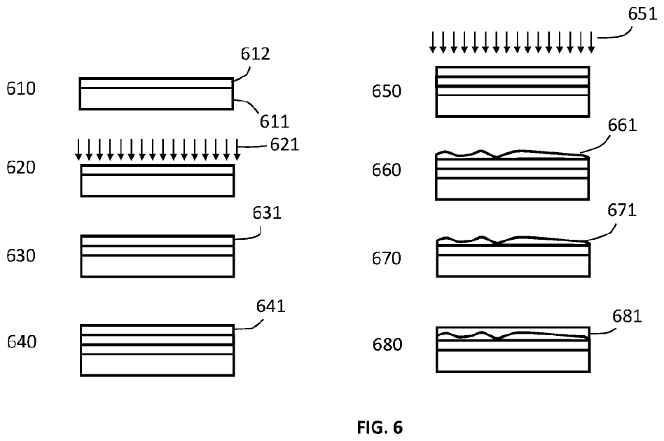

FIG. 6 illustrates a fabrication process for a spatially varying coating in accordance with an example embodiment. A photoalignment material 612 is coated on a transparent substrate 611 in step 610. Note that the dimensions in FIG. 6, such as the thicknesses, are not drawn to scale. In step 620, the sample is exposed to a spatially varying polarized ultraviolet light 621, which determines the alignment angle of the photoalignment material as a function of position. After a suitable temperature cycle to remove excess solvent and to fix the alignment angle of the photoalignment material, a layer of liquid crystal polymer 631 is coated on top of the photoalignment material in step 630. The sample is baked again to remove excess solvent and to fix the alignment angle of the liquid crystal polymer. In step 640, a photoresist 641 is coated on top of the liquid crystal polymer. In step 650, the photoresist is exposed to ultraviolet light 651 with spatially varying intensity. In step 660, the photoresist is baked and developed with the pattern in the light intensity transferred to a pattern in the photoresist thickness. In step 670, the patterned photoresist 661 is etched, and the pattern in the photoresist is transferred to a pattern in the liquid crystal polymer. In step 680, the patterned liquid crystal polymer 671 is coated with a barrier and planarization layer 681. In some embodiments, the angle of the liquid crystal polymer changes with position, and the thickness of the liquid crystal polymer is constant. In other embodiments, the angle of the liquid crystal polymer is constant, and the thickness of the liquid crystal polymer changes with position. In yet another embodiment, both the angle and thickness of the liquid crystal polymer change with position. The liquid crystal polymer can be A-plate, C-plate, J-plate or cholesteric liquid crystal polymer. An A-plate is a uniaxial birefringent optical element having its extraordinary axis oriented parallel to the plane of the plate. A C-plate is uniaxial birefringent optical element having its extraordinary axis oriented perpendicular to the plane of the plate. A J-plate is uniaxial birefringent optical element having its extraordinary axis oriented at a predetermined angle relative to the plane of the plate.

Examples of photoalignment materials are azodye, LIA-001 made by DIC Corp. Japan, and ROP108 made by Rolic Technologies, Switzerland. Examples of A-plate, C-plate and cholesteric liquid crystal polymer are EMD RMM141C, EMD RMM1704, and EMD RMM1695 made by EMD Electronics, The Electronics business of Merck KGaA, Darmstadt Germany. Example of planarization material is Norland optical adhesive NOA73 made by Norland Products, Jamesburg NJ.

It should be noted that for facilitating the explanation of the disclosed technology, the polarization aberration compensators have been described that operate in transmission. However, it is understood that the disclosed polarization aberration compensators can operate in reflection or a combination of reflection and transmission. It should be further noted that the terms coating group or group of coating are sometimes used herein (e.g., in connection with FIG. 4) to describe a set of coatings (or generally layers) that are designed to produce particular optical characteristics. In particular, the terms coatings and layers are sometimes used interchangeably, and the term coating should not be construed to limit the process of making the layer to a particular procedure or process.

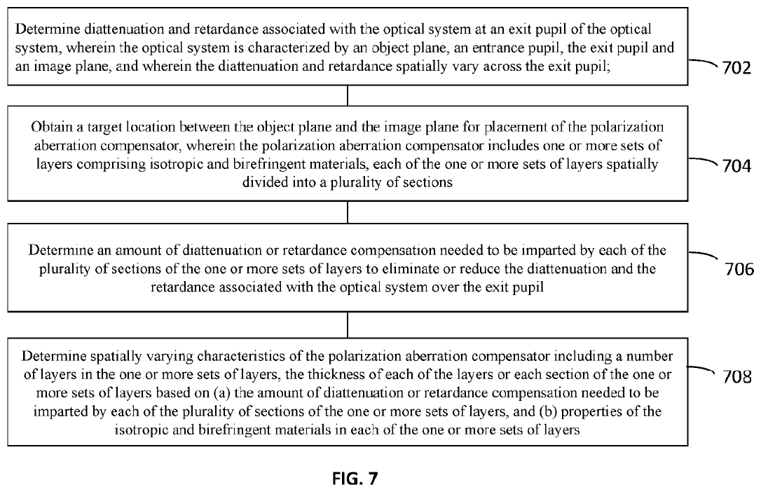

FIG. 7 illustrates a set of operations that can be carried out to design a polarization aberration compensator for an optical system in accordance with an example embodiment. At 702, diattenuation and retardance associated with the optical system at an exit pupil of the optical system is determined. The optical system is characterized by an object plane, an entrance pupil, the exit pupil and an image plane, and wherein the diattenuation and retardance spatially vary across the exit pupil. At 704, a target location between the object plane and the image plane for placement of the polarization aberration compensator is obtained. The polarization aberration compensator includes one or more sets of layers comprising isotropic and birefringent materials, each of the one or more sets of layers spatially divided into a plurality of sections. At 706, an amount of diattenuation or retardance compensation is determined to be imparted by each of the plurality of sections of the one or more sets of layers to eliminate or reduce the diattenuation and the retardance associated with the optical system over the exit pupil. At 708, spatially varying characteristics of the polarization aberration compensator are determined. The spatially varying characteristics include a number of layers in the one or more sets of layers, the thickness of each of the layers or each section of the one or more sets of layers, and these characteristics are determined based on (a) the amount of diattenuation or retardance compensation needed to be imparted by each of the plurality of sections of the one or more sets of layers, and (b) properties of the isotropic and birefringent materials in each of the one or more sets of layers.

In one example embodiment, polarization characteristics of the optical system includes a spatially varying Jones matrix that represents polarization aberrations of the optical system, and the amount of diattenuation or retardance compensation needed to be imparted by each of the plurality of sections is determined such that a product of the spatially varying Jones matrix of the optical system and a spatially varying Jones matrix of the polarization aberration compensator is equal to unity or a predetermined value. In another example embodiment, polarization characteristics of the optical system includes a spatially varying Muller matrix that represents polarization aberrations of the optical system, and the amount of diattenuation or retardance compensation needed to be imparted by each of the plurality of sections is determined such that a product of the spatially varying Muller matrix of the optical system and a spatially varying Muller matrix of the polarization aberration compensator is equal to unity or a predetermined value.

According to another example embodiment, the one or more sets of layers includes a first set of layers configured to impart a spatially varying diattenuation, and a second set of layers configured to impart a spatially varying retardance. In another example embodiment, each of the first and the second set of layers includes a photoalignment layer, and the method for designing the polarization aberration compensator further includes determining one or more angles of the photoalignment layer. In yet another example embodiment, the first set of layers includes a barrier and planarization layer, an A-plate liquid crystal polymer layer doped with a dichroic dye or a cholesteric liquid crystal polymer with or without doping with a dichroic material, and a photoalignment layer. In still another example embodiment, the second set of layers includes a barrier and planarization layer, a liquid crystal polymer layer, and a photoalignment layer.

In one example embodiment, the polarization aberration compensator further includes an additional set of layers configured to modify a transmission and angular response of the polarization aberration compensator. In another example embodiment, the additional set of layers includes an antireflection layer, a transparent barrier and planarization layer, a C-plate liquid crystal polymer layer, and a photoalignment layer. In still another example embodiment, the target location of the polarization aberration compensator is at the exit pupil. In another example embodiment, the target location of the polarization aberration compensator is a position other than the exit pupil between the object plane and the image plane.

One aspect of the disclosed embodiments relates to a device that includes a processor and a memory including instructions stored thereon. The instructions upon execution by the processor cause the processor to perform the methods described in the example embodiments.

Another aspect of the disclosed embodiments relates to a polarization aberration compensator that includes a substrate, and one or more sets of layers positioned on the substrate. Each of the one or more sets of layers is spatially divided into a plurality of sections, and each of the plurality of sections is configured to impart a different amount diattenuation or retardance compared to another one of the plurality of sections to form a spatially varying polarization correction configuration across the polarization aberration compensator. Additionally, the amount diattenuation or retardance imparted by each of the plurality of sections is customized based on polarization characteristics of a corresponding optical system to eliminate or reduce polarization aberrations over an exit pupil of the optical system.

In one example embodiment, the polarization characteristics of the optical system includes polarization aberrations represented by a spatially varying Jones matrix, and the amount diattenuation or retardance imparted by each of the plurality of sections is selected such that a product of the spatially varying Jones matrix of the optical system and a spatially varying Jones matrix of the polarization aberration compensator is equal to unity or a predetermined value. In another example embodiment, the polarization characteristics of the optical system includes polarization aberrations represented by a spatially varying Mueller matrix, and the amount diattenuation or retardance imparted by each of the plurality of sections is selected such that a product of the spatially varying Muller matrix of the optical system and a spatially varying Muller matrix of the polarization aberration compensator is equal to unity or a predetermined value.

In another example embodiment, the one or more sets of layers includes a first set of layers configured to impart a spatially varying diattenuation, and a second set of layers configured to impart a spatially varying retardance. In another example embodiment, the first set of layers includes a barrier and planarization layer, an A-plate liquid crystal polymer layer doped with a dichroic dye, and a photoalignment layer. In yet another example embodiment, the first set of layers includes a layer comprising a cholesteric liquid crystal polymer with or without doping with a dichroic material. In still another example embodiment, the second set of layers includes a barrier and planarization layer, a liquid crystal polymer layer, and a photoalignment layer. In one example embodiment, the liquid crystal polymer layer is an A-plate liquid crystal polymer layer.

According to another example embodiment, the polarization aberration compensator further includes an additional set of layers configured to modify a transmission and angular response of the polarization aberration compensator. In one example embodiment, the additional set of layers includes an antireflection layer, a transparent barrier and planarization layer, a C-plate liquid crystal polymer layer, and a photoalignment layer.

In another example embodiment, the one or more sets of layers includes multiple layers of isotropic and birefringent materials including at least one photoalignment layer, and a number of layers, a thickness of each layer, and one or more angles of the photoalignment layer are determined as part of customizing the amount diattenuation or retardance imparted by each of the plurality of sections to eliminate or reduce the polarization aberrations over the exit pupil of the optical system. In yet another example embodiment, a thickness of the plurality of sections varies over an area of the polarization aberration compensator. In still another example embodiment, the polarization aberration compensator further includes an antireflection coating.

According to another example embodiment, the polarization aberration compensator is included as part of the corresponding optical system that is characterized by an object plane, an entrance pupil, an exit pupil and an image plane, and the polarization aberration compensator is positioned in the optical system between the object plane and the image plane. In another example embodiment, the polarization aberration compensator is included as part of the corresponding optical system that is characterized by an object plane, an entrance pupil, an exit pupil and an image plane, and the polarization aberration compensator is positioned at the exit pupil. In yet another example embodiment, the polarization aberration compensator includes one or more additional substrates, wherein the polarization aberration compensator includes two or more sets of layers, and each additional substrate supports a corresponding set of layers.

It is understood that the various disclosed embodiments may be implemented individually, or collectively, using devices comprised of various optical components, electronics hardware and/or software modules and components. These devices, for example, may comprise a processor, a memory unit, an interface that are communicatively connected to each other, and may range from desktop and/or laptop computers, to mobile devices and the like. The processor and/or controller can perform various disclosed operations based on execution of program code that is stored on a storage medium. The processor and/or controller can, for example, be in communication with at least one memory and with at least one communication unit that enables the exchange of data and information, directly or indirectly, through the communication link with other entities, devices and networks. The communication unit may provide wired and/or wireless communication capabilities in accordance with one or more communication protocols, and therefore it may comprise the proper transmitter/receiver antennas, circuitry and ports, as well as the encoding/decoding capabilities that may be necessary for proper transmission and/or reception of data and other information. For example, the processor may be configured to determine the desired Jones matrix for the disclosed polarization aberration compensators, determine the desired number and thicknesses of the layers (or sections thereof), to control optical light sources, and be configured perform other operations based on the techniques disclosed herein.

Various information and data processing operations described herein may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media that is described in the present application comprises non-transitory storage media. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

The foregoing description of embodiments has been presented for purposes of illustration and description. The foregoing description is not intended to be exhaustive or to limit embodiments of the present invention to the precise form disclosed, and modifications and variations are possible in light of the above teachings or may be acquired from practice of various embodiments. The embodiments discussed herein were chosen and described in order to explain the principles and the nature of various embodiments and its practical application to enable one skilled in the art to utilize the present invention in various embodiments and with various modifications as are suited to the particular use contemplated. While operations are depicted in the drawings in a particular order, this should not be understood as requiring that such operations be performed in the particular order shown or in sequential order, or that all illustrated operations be performed, to achieve desirable results. The features of the embodiments described herein may be combined in all possible combinations of methods, apparatus, modules, and systems.

1. A polarization aberration compensator, comprising:
a substrate; and
one or more sets of layers positioned on the substrate, wherein:
each of the one or more sets of layers is spatially divided into a plurality of sections,
each of the plurality of sections is configured to impart a different amount diattenuation or retardance compared to another one of the plurality of sections to form a spatially varying polarization correction configuration across the polarization aberration compensator, and
the amount diattenuation or retardance imparted by each of the plurality of sections is customized based on polarization characteristics of a corresponding optical system to eliminate or reduce polarization aberrations over an exit pupil of the optical system.

2. The polarization aberration compensator of claim 1, wherein the polarization characteristics of the optical system includes polarization aberrations represented by a spatially varying Jones matrix, and the amount diattenuation or retardance imparted by each of the plurality of sections is selected such that a product of the spatially varying Jones matrix of the optical system and a spatially varying Jones matrix of the polarization aberration compensator is equal to unity or a predetermined value.

3. The polarization aberration compensator of claim 1, wherein the polarization characteristics of the optical system includes polarization aberrations represented by a spatially varying Mueller matrix, and the amount diattenuation or retardance imparted by each of the plurality of sections is selected such that a product of the spatially varying Muller matrix of the optical system and a spatially varying Muller matrix of the polarization aberration compensator is equal to unity or a predetermined value.

4. The polarization aberration compensator of claim 1, wherein the one or more sets of layers includes:
a first set of layers configured to impart a spatially varying diattenuation, and
a second set of layers configured to impart a spatially varying retardance.

5. The polarization aberration compensator of claim 4, wherein:
the first set of layers includes a barrier and planarization layer, an A-plate liquid crystal polymer layer doped with a dichroic dye, and a photoalignment layer.

6. The polarization aberration compensator of claim 4, wherein:
the first set of layers includes a layer comprising a cholesteric liquid crystal polymer.

7. The polarization aberration compensator of claim 4, wherein:
the second set of layers includes a barrier and planarization layer, a liquid crystal polymer layer, and a photoalignment layer.

8. The polarization aberration compensator of claim 7, wherein the liquid crystal polymer layer is an A-plate liquid crystal polymer layer.

9. The polarization aberration compensator of claim 4, further including an additional set of layers configured to modify a transmission and angular response of the polarization aberration compensator.

10. The polarization aberration compensator of claim 9, wherein:
the additional set of layers includes an antireflection layer, a transparent barrier and planarization layer, a C-plate liquid crystal polymer layer, and a photoalignment layer.

11. The polarization aberration compensator of claim 1, wherein:
the one or more sets of layers includes multiple layers of isotropic and birefringent materials including at least one photoalignment layer, and
a number of layers, a thickness of each layer, and one or more angles of the photoalignment layer are determined as part of customizing the amount diattenuation or retardance imparted by each of the plurality of sections to eliminate or reduce the polarization aberrations over the exit pupil of the optical system.

12. The polarization aberration compensator of claim 1, wherein a thickness of the plurality of sections varies over an area of the polarization aberration compensator.

13. The polarization aberration compensator of claim 1, further including an antireflection coating.

14. The polarization aberration compensator of claim 1, wherein:
the polarization aberration compensator is included as part of the corresponding optical system that is characterized by an object plane, an entrance pupil, an exit pupil and an image plane, and
the polarization aberration compensator is positioned in the optical system between the object plane and the image plane.

15. The polarization aberration compensator of claim 1, wherein:
the polarization aberration compensator is included as part of the corresponding optical system that is characterized by an object plane, an entrance pupil, an exit pupil and an image plane, and
the polarization aberration compensator is positioned at the exit pupil.

16. The polarization aberration compensator of claim 1, including one or more additional substrates, wherein the polarization aberration compensator includes two or more sets of layers, and each additional substrate supports a corresponding set of layers.

17. A method for designing a polarization aberration compensator for an optical system, the method comprising:
determining diattenuation and retardance associated with the optical system at an exit pupil of the optical system, wherein the optical system is characterized by an object plane, an entrance pupil, the exit pupil and an image plane, and wherein the diattenuation and retardance spatially vary across the exit pupil;
obtaining a target location between the object plane and the image plane for placement of the polarization aberration compensator, wherein the polarization aberration compensator includes one or more sets of layers comprising isotropic and birefringent materials, each of the one or more sets of layers spatially divided into a plurality of sections;
determining an amount of diattenuation or retardance compensation needed to be imparted by each of the plurality of sections of the one or more sets of layers to eliminate or reduce the diattenuation and the retardance associated with the optical system over the exit pupil; and
determining spatially varying characteristics of the polarization aberration compensator including a number of layers in the one or more sets of layers, the thickness of each of the layers or each section of the one or more sets of layers based on (a) the amount of diattenuation or retardance compensation needed to be imparted by each of the plurality of sections of the one or more sets of layers, and (b) properties of the isotropic and birefringent materials in each of the one or more sets of layers.

18. The method of claim 17, wherein:
the optical system is characterized by a spatially varying Jones matrix that represents polarization aberrations of the optical system, and
the amount of diattenuation or retardance compensation needed to be imparted by each of the plurality of sections is determined such that a product of the spatially varying Jones matrix of the optical system and a spatially varying Jones matrix of the polarization aberration compensator is equal to unity or a predetermined value.

19. The method of claim 17, wherein:
the optical system is characterized by a spatially varying Muller matrix that represents polarization aberrations of the optical system, and
the amount of diattenuation or retardance compensation needed to be imparted by each of the plurality of sections is determined such that a product of the spatially varying Muller matrix of the optical system and a spatially varying Muller matrix of the polarization aberration compensator is equal to unity or a predetermined value.

20. The method of claim 17, wherein the one or more sets of layers includes:
a first set of layers configured to impart a spatially varying diattenuation, and
a second set of layers configured to impart a spatially varying retardance.

21. The method of claim 20, wherein each of the first and the second set of layers includes a photoalignment layer, and the method further includes determining one or more angles of the photoalignment layer.

22. The method of claim 20, wherein the first set of layers includes a barrier and planarization layer, an A-plate liquid crystal polymer layer doped with a dichroic dye or a cholesteric liquid crystal polymer, and a photoalignment layer.

23. The method of claim 20, wherein the second set of layers includes a barrier and planarization layer, a liquid crystal polymer layer, and a photoalignment layer.

24. The method of claim 20, wherein the polarization aberration compensator further includes an additional set of layers configured to modify a transmission and angular response of the polarization aberration compensator.

25. The method of claim 24, wherein the additional set of layers includes an antireflection layer, a transparent barrier and planarization layer, a C-plate liquid crystal polymer layer, and a photoalignment layer.

26. The method of claim 17, wherein the target location of the polarization aberration compensator is at the exit pupil.

27. The method of claim 17, wherein the target location of the polarization aberration compensator is a position other than the exit pupil between the object plane and the image plane.

28. (canceled)
